(19) United States
(12) Patent Application Publication
(10) Pub. No.: US 2023/0102849 A1
(43) Pub. Date: Mar. 30, 2023

(54) METHOD FOR PRODUCING OPTICAL FIBER AND APPARATUS FOR PRODUCING OPTICAL FIBER

(71) Applicant: SUMITOMO ELECTRIC INDUSTRIES, LTD., Osaka-shi, Osaka (JP)

(72) Inventors: Takahiro NOMURA, Osaka-shi, Osaka (JP); Kazuyuki SOHMA, Osaka-shi, Osaka (JP)

(73) Assignee: SUMITOMO ELECTRIC INDUSTRIES, LTD., Osaka-shi, Osaka (JP)

(21) Appl. No.: 17/802,333

(22) PCT Filed: Feb. 26, 2021
(86) PCT No.: PCT/JP2021/007528

§ 371 Date: Aug. 25, 2022

(30) Foreign Application Priority Data
Feb. 26, 2020 (JP) 2020-030232

(51) Int. Cl. C03C 25/6226; C03C 25/105

(52) U.S. Cl. CPC C03C 25/6226; C03C 25/105

(57) ABSTRACT

A method for producing an optical fiber coated with a UV-curable resin material around a glass fiber includes: a step of applying the UV-curable resin material to the periphery of the glass fiber; a step of passing the glass fiber coated with the UV-curable resin material through an interior of a cylindrical body (illustrated with a quartz tube) capable of transmitting UV light; a step of irradiating UV light from outside the cylindrical body by using a light source (illustrated with a UV bulb) to cure the glass fiber and form a coating; and a step of controlling (illustrated with a power controller) a power input to the light source so that a cure extent of the coating is constant based on the illuminance of the UV light from the light source and the illuminance of the UV light transmitted through the cylindrical body.

### TECHNICAL FIELD

The present disclosure relates to a method for producing an optical fiber and an apparatus for producing an optical fiber.

The present application claims the benefit of priority of Japanese Patent Application No. 2020-030232, filed on Feb. 26, 2020, the content of which is incorporated herein by reference.

### BACKGROUND ART

Patent Literature 1 discloses an ultraviolet irradiation device that controls the power input to a light source so that the illuminance of UV (ultraviolet) light transmitted through a quartz tube (hereinafter referred to as light transmitted through the quartz tube) is constant.

### CITATION LIST

### Patent Literature

Patent Literature 1: JP-A-2005-162524

### SUMMARY OF INVENTION

A method for producing optical fiber according to an aspect of the present disclosure includes:

An apparatus for producing optical fiber according to an aspect of the present disclosure includes:

### BRIEF DESCRIPTION OF DRAWINGS

FIG. 1 is a schematic diagram of an optical fiber manufacturing apparatus according to an aspect of the present disclosure.

FIG. 2A is a diagram illustrating an example of a UV irradiation furnace.

FIG. 2B is a diagram illustrating an example of a UV irradiation furnace.

FIG. 3 is a diagram illustrating a control device in the embodiment.

### DESCRIPTION OF EMBODIMENTS

### Problem to be Solved by Present Disclosure

UV light from the light source passes through the peripheral wall of the quartz tube (in detail, the peripheral wall on the front side as seen from the light source) and enters the interior of the quartz tube, and again passes through the peripheral wall of the quartz tube (in detail, the peripheral wall on the back side as seen from the light source) and exits outside the quartz tube and is detected as transmitted light of the quartz tube by a sensor located outside the quartz tube. If the quartz tube is fogged, the light transmitted through the quartz tube is attenuated at the fogged portion of the front side peripheral wall and then further attenuated at the fogged portion of the rear side peripheral wall, and is detected by the sensor, which detects a smaller value than the illuminance of the UV light inside the quartz tube, which is transmitted through the rear side peripheral wall The sensor detects a value that is smaller than the value of the UV light transmitted through the quartz tube.

Therefore, when the power input to the light source is controlled so that the illuminance of the light transmitted through the quartz tube is constant, the illuminance of the UV light from the light source becomes larger than that originally required for curing a coating inside the quartz tube to compensate for the further attenuation due to transmission through the peripheral wall on the far side. This means that as the quartz tube becomes cloudier, the illuminance of the UV light inside the quartz tube gradually increases and a cure extent of the coating gradually increases, and the cure extent of the coating is not uniform in a longitudinal direction of the optical fiber. Therefore, it is desirable to make the cure extent of the coating uniform in the longitudinal direction of the optical fiber.

### Advantageous Effects of Disclosure

According to the present disclosure, the cure extent of the coating can be made uniform in the longitudinal direction of the optical fiber.

### DESCRIPTION OF EMBODIMENTS OF PRESENT DISCLOSURE

First, embodiments of the present disclosure will be listed and described.

A method for producing optical fiber according to the present disclosure is:

(1) a method for producing an optical fiber coated with a UV-curable resin material around a glass fiber, comprising: a step of applying the UV-curable resin material to the periphery of the glass fiber; a step of passing the glass fiber coated with the UV-curable resin material through an interior of a cylindrical body capable of transmitting UV light; a step of irradiating UV light from outside the cylindrical body by using a light source to cure the glass fiber and form a coating; and a step of controlling a power input to the light source so that a cure extent of the coating is constant based on the illuminance of the UV light from the light source and the illuminance of the UV light transmitted through the cylindrical body.

In this method, the illuminance of the UV light from the light source and the illuminance of the UV light transmitted through the cylindrical body are acquired, and the power input to the light source is controlled so that the illuminance of the UV light inside the cylindrical body is constant. Therefore, there is no need to compensate for the amount of the UV light transmitted through the back peripheral wall, as is the case when the illuminance of the UV light transmitted through the cylindrical body is constant. Therefore, the cure extent of the coating can be made uniform in the longitudinal direction of the optical fiber.

(2) In an aspect of the method for producing optical fiber according to the present disclosure, in the step of controlling the power input to the light source, the power is controlled based on the product of the illuminance of the UV light from the light source and the illuminance of the UV light transmitted through the cylindrical body.

Since the product of the illuminance of the UV light from the light source and the illuminance of the UV light transmitted through the cylindrical body corresponds to a characteristic that correlates with the cure extent of the coating due to UV irradiation, if the power input to the light source is controlled so that this product is constant, it is easy to make the cure extent uniform in the longitudinal direction of the optical fiber.

An apparatus for producing an optical fiber according to the present disclosure is:

(3) an apparatus for producing an optical fiber coated with a UV-curable resin material, comprising: a cylindrical body configured to allow transmission of UV light, through which a glass fiber coated with a UV-curable resin material is passed; a UV irradiation furnace including a light source which irradiates the UV light to the UV-curable resin material from outside the cylindrical body; and a power controller configured to control the power input to the light source so that the cure extent of the coating of the UV-cured resin material is constant based on the illuminance of the UV light from the light source and the illuminance of the UV light transmitted through the cylindrical body.

In this apparatus, the illuminance of the UV light from the light source and the illuminance of the UV light transmitted through the cylindrical body are acquired, and the power input to the light source is controlled so that the illuminance of the UV light inside the cylindrical body is constant. Therefore, the cure extent of the coating can be made uniform in the longitudinal direction of the optical fiber.

(4) In an aspect of the apparatus for producing the optical fiber according to the present disclosure, wherein the power controller controls the power input to the light source based on the product of the illuminance of the UV light from the light source and the illuminance of the UV light transmitted through the cylindrical body.

Since the product of the illuminance of the UV light from the light source and the illuminance of the UV light transmitted through the cylindrical body corresponds to a characteristic that correlates with the cure extent of the coating due to irradiation with UV light, controlling the power input to the light source so that the product is constant makes it easier to make the cure extent of the coating uniform along the length of the optical fiber.

(5) In an aspect of the apparatus for producing the optical fiber according to the present disclosure, wherein the power controller determines the illuminance of the UV light in the cylindrical body from the illuminance of the UV light form the light source and the illuminance of the UV light transmitted through the cylindrical body, and controls the power input to the light source based on the determined illuminance of the UV light in the cylindrical body.

If the illuminance of UV light in the cylindrical body is determined and the power input to the light source is controlled so that the illuminance of UV light in the cylindrical body is constant, it is easy to make the cure extent of the coating uniform in the longitudinal direction of the optical fiber.

(6) In an aspect of the apparatus for producing the optical fiber according to the present disclosure, further comprising: a gas blowing mechanism configured to blow gas onto a UV sensor which measures the illuminance of the UV light passed through the cylindrical body.

Since the UV sensor is sprayed with gas from the gas blowing mechanism, the adhesion of a volatile component can be suppressed.

### DETAILS OF EMBODIMENTS OF THE PRESENT DISCLOSURE

A specific example of a method for producing an optical fiber and an apparatus for producing an optical fiber according to the present disclosure will be described hereinafter with reference to the drawings.

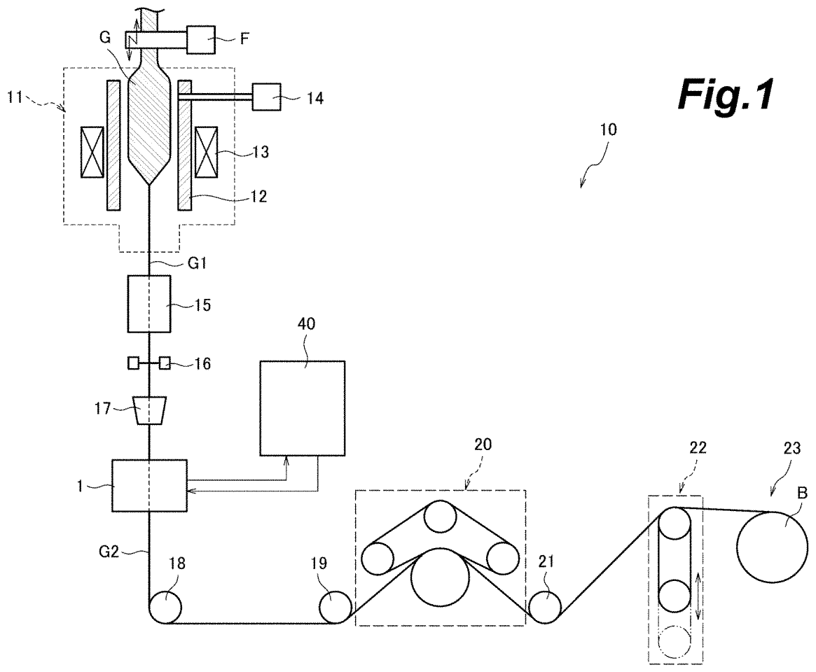

FIG. 1 is a diagram showing an example of an optical fiber manufacturing apparatus 10.

As shown in FIG. 1, the optical fiber manufacturing apparatus 10 includes a drawing furnace 11 at the upstream position, which heats and softens an optical fiber preform G.

The drawing furnace 11 consists of a cylindrical core tube 12 into which the optical fiber preform G is supplied inside, a heating element 13 that surrounds the core tube 12, and a heating element 14 that is used to heat and soften the optical fiber preform G. The drawing furnace 11 has a cylindrical core tube 12 in which the optical fiber preform G is supplied inside, a heating element 13 that surrounds the core tube 12, and a gas supply unit 14 that supplies inert gas inside the core tube 12. The heating element 13 can be a resistance furnace or an induction furnace.

The upper part of the optical fiber preform G is gripped by a preform feeding unit F, and the optical fiber preform G is fed into the core tube 12 by the preform feeding unit F. The optical fiber matrix G is fed into the core tube 12 by the preform feeding unit F. When the bottom end of the optical fiber base metal G is heated by the heating element 13 and drawn downward, a glass fiber G1, which is a component of the optical fiber G2, is formed. The glass fiber G1 is an optical waveguide having a core and a cladding section and a standard outer diameter of, for example, 125 μm.

The optical fiber manufacturing apparatus 10 is equipped with a cooling unit 15 downstream of the drawing furnace 11. The cooling unit 15 is supplied with a cooling gas of helium gas, for example, and the glass fiber G1 drawn from the optical fiber preform G is cooled in the cooling unit 15 is cooled in the cooling unit 15. The optical fiber manufacturing apparatus 10 is equipped with an outside diameter measurement unit 16 downstream of the cooling unit 15. The outer diameter measurement unit 16 is configured to measure the outer diameter of the glass fiber G1 using, for example, a laser beam. The glass fiber G1 cooled by the cooling unit 15 is sent downstream after its outside diameter is measured by the outside diameter measurement unit 16. The outside diameter measurement unit 16 may use a measurement method other than laser light as long as the outside diameter of the glass fiber G1 can be measured in a non-contact manner.

The optical fiber manufacturing apparatus 10 is equipped with a resin coating unit 17 for UV-curable resin material downstream of the outer diameter measurement unit 16 and a UV curing furnace 1. The UV curing furnace 1 corresponds to the UV irradiation furnace of the present disclosure. In the resin application device 17, UV-curable resin material for glass fiber protection, for example, is stored. The UV-curable resin material (e.g., urethane acrylate resin) is applied to the glass fiber G1 whose outer diameter has been measured by the resin coating device 17, and this UV-curable resin material is the UV-curable resin material is cured by UV irradiation in the UV curing furnace 1. This results in an optical fiber G2 with a coating formed around the glass fiber G1 by the UV-curable resin material.

The UV-curable resin material for glass fiber protection may be composed of a primary (primary) resin and a secondary (secondary) resin. In this case, a resin coating device for the primary coating and a first UV curing furnace are provided, and downstream of the first UV curing furnace, a resin coating device for the secondary coating and a second UV curing furnace are provided. A second UV curing furnace is installed downstream of the first UV curing furnace. Alternatively, a resin coating device storing UV-curable resin raw materials for coloring is provided, and the optical fiber core wire may be coated with UV-curable resin for coloring on the optical fiber G2. Therefore, in addition to the optical fiber G2, the optical fiber core wire also corresponds to the optical fiber of the present disclosure.

The optical fiber manufacturing apparatus 10 is downstream of the UV curing furnace 1 and is equipped with a directly-under roller 18 and a guide roller 19 downstream of the UV curing furnace 1. The directly-under roller 18 is positioned directly below the drawing furnace 11, and the running direction of the optical fiber G2 is changed from a vertical direction to, for example, a horizontal direction. The directly-under roller 18 changes the running direction of the optical fiber G2 from vertical to horizontal. The optical fiber G2, whose running direction is changed by the directly-under roller 18, is guided by the guide roller to change its running direction from horizontal to, for example, diagonally upward.

The optical fiber manufacturing apparatus 10 further comprises, downstream of the guide roller 19, a take-up device 20, a guide roller 21, a dancer roller 22, and a take-up device 23. The optical fiber G2 is pulled at a predetermined speed by the capstan of the take-up device 20 and is wound onto a bobbin B of the take-up device 23 via the dancer roller 22.

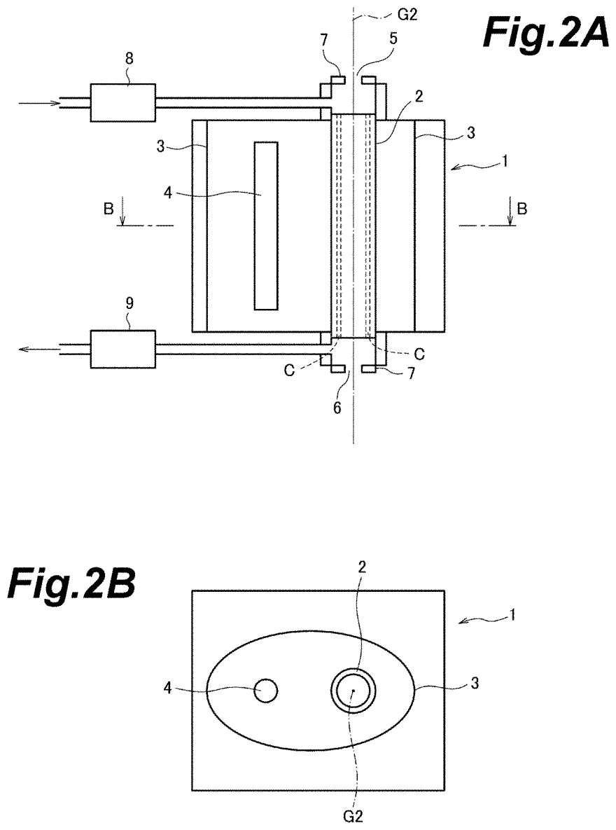

FIGS. 2A and 2B are diagrams showing an example of a UV curing furnace 1.

The UV curing furnace 1 includes a cylindrical quartz tube 2, a UV bulb 4 positioned outside the quartz tube 2 and a reflector 3 for focusing the UV light from the UV bulb 4 onto the optical fiber G2. The quartz tube 2 is translucent with respect to the UV light and is arranged so that the central axis of the quartz tube 2 is the position through which the optical fiber G2 passes. The quartz tube 2 corresponds to the cylindrical body of the present disclosure.

The UV bulb 4 includes, for example, a UV-LED (Light Emitting Diode) light source and is capable of irradiating UV light to the optical fiber G2. Instead of a UV-LED light source, a UV lamp that radiates UV light by discharge in mercury vapor may be used. UV lamps may be used instead of UV-LED light sources. Reflector 3 is positioned so as to surround quartz tube 2 and UV bulb 4. The UV light emitted from UV bulb 4 is reflected by reflector 3 and irradiated to quartz tube 2.

A purge gas containing an inert gas such as, for example, helium gas or nitrogen gas is supplied down flow into the quartz tube 2. In detail, the upper end side of the quartz tube 2 is connected to a gas supply channel, and purge gas whose flow rate is adjusted by the flow rate regulator 8 is supplied into the quartz tube 2 from the upper end side of the quartz tube 2. The lower end side of the quartz tube 2 is connected to the gas discharge channel, where purge gas supplied into the quartz tube 2, and purge gas from an inlet 5 and an outlet 6, air and other gases that enter the quartz tube 2 from the quartz tube 2 are discharged from the bottom end side of the quartz tube 2.

The presence of oxygen in the quartz tube 2 inhibits the UV curing reaction to the UV-curable resin material. Therefore, by increasing the flow rate of the purge gas, the concentration of the purge gas in the quartz tube 2 is increased and the oxygen concentration in the quartz tube 2 is lowered. The oxygen concentration in the quartz tube 2 is controlled by adjusting the opening degrees of shutters 7 at the inlet 5 and outlet 6, or by exhausting the gas in the quartz tube 2 with a suction pump 9 in the discharge channel. The oxygen concentration in the quartz tube 2 may be adjusted by adjusting the opening of the shutters 7 at the inlet 5 and outlet 6, or by exhausting the gas in the quartz tube 2 with the suction pump 9 installed in the discharge path. The inner surface of the quartz tube 2 is provided with a photocatalytic coating layer C. The photocatalytic coating layer C consists mainly of titanium dioxide (TiO2) and a binder component. The coating solution, which is a mixture of titanium dioxide and binder components, is applied to the inner surface of the quartz tube 2. For example, it is heated and baked onto the inner surface of the quartz tube 2.

The optical fiber G2 is introduced into the quartz tube 2 from the inlet 5 of the UV curing oven 1. The optical fiber G2 passes through the interior of the quartz tube 2, and is sent out of the quartz tube 2 from the outlet 6 of the UV curing furnace 1 toward the directly-under roller 18. The UV light from the UV bulb 4 is irradiated onto the optical fiber G2 that is passing through the inside of the quartz tube 2 from the outside of the quartz tube 2. The irradiation of the UV light progresses the hardening of the coating of the optical fiber G2, and in the present disclosure, the illuminance of the UV light transmitted through the quartz tube 2 is detected, and a control device 40 detects the illuminance based on this detection result. Based on this detection, the power input to the light source of the UV bulb 4 is controlled so that the cure extent of the coating is constant.

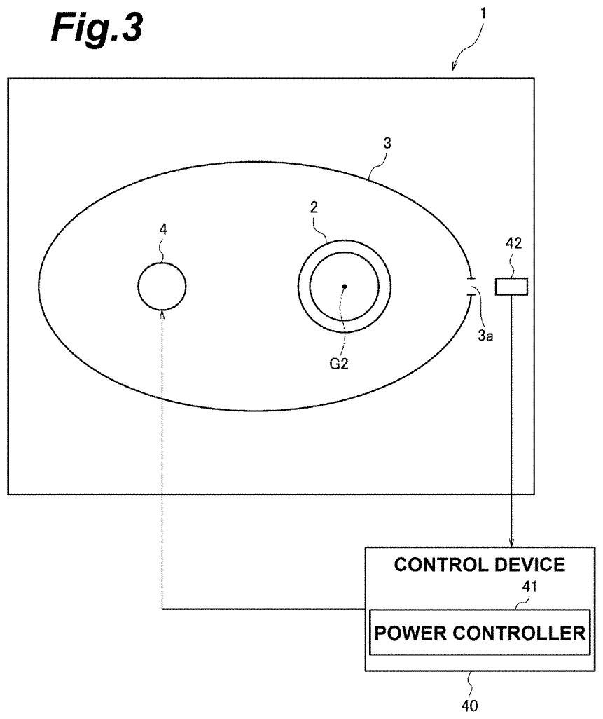

As shown in FIG. 3, the UV sensor 42 is positioned on the opposite side of the UV bulb 4 across the quartz tube 2. The UV light transmitted through the quartz tube 2 comes out through a hole 3a in the reflecting mirror 3 (or the gap between the mirror sections when the reflecting mirror 3 is composed of multiple mirror sections) and is detected by the UV sensor 42. The detection result is output to the control device 40. The control device 40 has, for example, one or more CPU (Central Processing Unit), etc., and is configured with, for example, one or more Various programs and data stored in ROM (Read Only Memory) are loaded into RAM (Random Access Memory). RAM (Random Access Memory) and executes the programs in the loaded RAM. This enables the operation of the optical fiber manufacturing apparatus 10 to be controlled.

The control device 40 also includes a power controller 41. The power controller 41 calculates I_{F} of the UV light in the quartz tube 2 from the illuminance Iᵢₙ of the UV light irradiated toward the quartz tube 2 and the illuminance Iₒᵤₜ of the UV light transmitted through the quartz tube 2, and control the power input to the light source based on the calculated illuminance I_{F} of the UV light. The illuminance Iᵢₙ of the UV light irradiated toward the quartz tube 2 corresponds to the illuminance of the UV light of the light source in the present disclosure. The illuminance L. of the UV light can be substituted for the power input to the light source, and it can also be monitored. When monitoring, the illuminance of the UV light is measured at a position on a straight line connecting the center of the light source and the quartz tube 2, before the UV light is transmitted through the quartz tube 2. The position of the measurement should be closer to the quartz tube 2.

The following is an example where the UV light transmitted through the quartz tube 2 is modeled as light transmitted along the same straight line from the light source along the horizontal direction (the same as the radial direction of the quartz tube 2). In this case, it is assumed that the volatile components of the UV-curable resin material adhere to the inner surface of the quartz tube 2 with uniform thickness. From Lambert-Beer's law, the illuminance I_{F} of the UV light in the quartz tube 2 is shown in Equation 1, and the illuminance Iₒᵤₜ of the UV light transmitted through the quartz tube 2 is shown in Equation 2, respectively.

I_{F}=Iᵢₙe^{-αl-αglg} Equation 1

Iₒᵤₜ=I_{F}e^{-αl-αglg} Equation 2

α is the absorption coefficient of the volatile components adhered to the quartz tube 2, l is the thickness of the volatile components adhered to the quartz tube 2, αg is the absorption coefficient of the quartz tube 2, and lg is the thickness of the quartz tube 2.

Eliminating e^{-αl-αglg} from these equations 1 and 2, I_{F}=Iᵢₙ (Iₒᵤₜ/I_{F}), the following equation 3 can be obtained.

I_{F}=·(Iᵢₙ×Iₒᵤₜ) Equation 3

Note that the illuminance Iₒᵤₜ of the UV light transmitted through the quartz tube 2 is measured by the UV sensor 42 because a part of the UV light is blocked by the optical fiber G2. However, since the outer diameter of the optical fiber G2 is small, the effect of a part of the UV light being blocked on the measured value is small and can be ignored.

The power controller 41 controls the power input to the light source of the UV bulb 4 so that the cure extent of the coating is constant within a predetermined range. For example, if the illuminance I_{F} of the UV light in the quartz tube 2 is determined to be small, the cure extent of the coating is low and the power controller 41 outputs a signal to the UV bulb 4 to increase the power input to the light source. As a result, the illuminance Iᵢₙ of the UV irradiated toward the quartz tube 2 becomes larger, so the illuminance I_{F} of the UV light in the quartz tube 2 can be increased.

Thus, the illuminance Iᵢₙ of the UV light irradiated toward quartz tube 2 and the illuminance Iₒᵤₜ are obtained, and the power input to the light source is controlled so that the illuminance I_{F} of the UV light in the quartz tube 2 is constant. Therefore, there is no extra compensation for the amount of the UV light transmitted through the back peripheral wall, as is the case when the illuminance Iₒᵤₜ of the UV light transmitted through the quartz tube 2 is kept constant. Thus, the cure extent of the coating can be made uniform in the length direction of the optical fiber.

The detection position of the illuminance Iₒᵤₜ of the UV light transmitted through the quartz tube 2 is preferably between the center and the lower end of the quartz tube 2, for example. The reason for this is that the cloudiness of the quartz tube tends to worsen at the lower end.

In the above example, the illuminance I_{F} of the UV light in the quartz tube 2 is obtained from the square root of the product of the illuminance Iᵢₙ of the UV light irradiated toward quartz tube 2 and the illuminance Iₒᵤₜ of the UV light transmitted through quartz tube 2. However, the present disclosure is not limited to the above example. For example, the power input to the light source may be controlled based on another relational equation using the illuminance Iᵢₙ of the UV light directed toward the quartz tube 2 and the illuminance Iₒᵤₜ of the UV light transmitted through the quartz tube 2.

Alternatively, in the above example, the illuminance Iₒᵤₜ of the UV light transmitted through the quartz tube 2 is monitored and the power input to the light source is controlled so that the cure extent of the coating is constant. However, a UV sensor is installed near the opening at the bottom end of the quartz tube 2, for example, to monitor the illuminance of the UV light in the quartz tube 2 (the illuminance of the UV light that directly hits the coating of the optical fiber G2) I_{F} can be monitored, and the power input to the light source can be controlled so that the cure extent of the coating remains constant.

A problem in determining the illuminance inside the quartz tube 2 is that the sensor itself is clouded by volatile components, making accurate measurement difficult. Therefore, the sensor itself is sprayed with gas to inhibit the adhesion of volatile components. To suppress the inhibition of curing of the UV-curable resin material by oxygen, the quartz tube 2 is basically filled with an inert gas. Therefore, inert gas is preferred as the spraying gas. A variant in which oxygen-containing gas is sprayed aiming at oxidative decomposition of adhered volatile components is also effective. Furthermore, coating the sensor itself with titanium oxide, which is a photocatalyst, is also effective. A gas flow rate of at least 5 L/min is preferred because volatile components need to be blown away.

The presently disclosed embodiments should in all respects be considered illustrative and not restrictive. The scope of the present disclosure is indicated by the claims, not in the sense given above, and is intended to include all modifications within the meaning and scope of the claims and equivalents.

### REFERENCE SIGNS LIST

1 . . . UV curing furnace (UV irradiation furnace), 2 . . . quartz tube (cylindrical body), 3 . . . reflector 3a . . . hole, 4 . . . UV bulb (light source), 5 . . . inlet, 6 . . . outlet, 6 . . . outlet, 7 . . . shutter, 8 . . . flow rate regulator, 9 . . . suction pump, 10 . . . optical fiber manufacturing apparatus (apparatus for producing optical fiber), 11 . . . drawing furnace, 12 . . . Furnace core tube, 13 . . . Heating element, 14 . . . Gas supply unit, 15 . . . Cooling unit, 16 . . . O.D. measuring unit, 17 . . . Resin coating unit 18 . . . Direct roller, 19, 21 . . . Guide roller, 20 . . . Take-up roller, 20 . . . Take-up roller, 20 . . . Take-up roller 20 . . . Take-up device, 22 . . . Dancer roller, 23 Take-up device, 40 . . . control device, 41 . . . power controller, 42 . . . UV sensor, B . . . bobbin, C . . . photocatalytic coating layer, F . . . preform feeding unit, G . . . optical fiber preform, G1 . . . glass fiber, G2 . . . optical fiber.

1. A method for producing an optical fiber coated with a UV-curable resin material around a glass fiber, comprising:
a step of applying the UV-curable resin material to the periphery of the glass fiber;
a step of passing the glass fiber coated with the UV-curable resin material through an interior of a cylindrical body capable of transmitting UV light;
a step of irradiating UV light from outside the cylindrical body by using a light source to cure the UV-curable resin material and form a coating; and
a step of controlling a power input to the light source so that a cure extent of the coating is constant based on the illuminance of the UV light from the light source and the illuminance of the UV light transmitted through the cylindrical body.

2. The method for producing an optical fiber according to claim 1, wherein
in the step of controlling the power input to the light source, the power is controlled based on the product of the illuminance of the UV light from the light source and the illuminance of the UV light transmitted through the cylindrical body.

3. An apparatus for producing an optical fiber coated with a UV-curable resin material, comprising:
a cylindrical body configured to allow transmission of UV light, through which a glass fiber coated with a UV-curable resin material is passed;
a UV irradiation furnace including a light source which irradiates the UV light to the UV-curable resin material from outside the cylindrical body; and
a power controller configured to control the power input to the light source so that a cure extent of a coating comprising the cured UV-curable resin material is constant based on the illuminance of the UV light from the light source and the illuminance of the UV light transmitted through the cylindrical body.

4. The apparatus for producing the optical fiber according to claim 3, wherein
the power controller controls the power input to the light source based on the product of the illuminance of the UV light from the light source and the illuminance of the UV light transmitted through the cylindrical body.

5. The apparatus for producing the optical fiber according to claim 3, wherein
the power controller determines the illuminance of the UV light in the cylindrical body from the illuminance of the UV light form the light source and the illuminance of the UV light transmitted through the cylindrical body, and controls the power input to the light source based on the determined illuminance of the UV light in the cylindrical body.

6. The apparatus for producing the optical fiber according to claim 3, further comprising:
a gas blowing mechanism configured to blow gas onto a UV sensor which measures the illuminance of the UV light passed through the cylindrical body.

7. The apparatus for producing the optical fiber according to claim 4, further comprising:
a gas blowing mechanism configured to blow gas onto a UV sensor which measures the illuminance of the UV light passed through the cylindrical body.

8. The apparatus for producing the optical fiber according to claim 5, further comprising:
a gas blowing mechanism configured to blow gas onto a UV sensor which measures the illuminance of the UV light passed through the cylindrical body.
